(19) United States
(12) Patent Application Publication
(10) Pub. No.: US 2011/0262698 A1
(43) Pub. Date: Oct. 27, 2011

(54) CONTROL PANEL, KEYBOARD MODULE AND METHOD FOR THE MANUFACTURE THEREOF

(75) Inventors: Achim Lerner, Borken (DE); Jörg Ernsten, Bocholt (DE)

(73) Assignee: Gigaset Communications GMBH, Munchen (DE)

(21) Appl. No.: 13/126,094

(22) PCT Filed: Oct. 27, 2009
(86) PCT No.: PCT/EP2009/064152

§ 371 Date: Jul. 15, 2011

(30) Foreign Application Priority Data
Oct. 27, 2008 (DE) 10 2008 053 351.3

(51) Int. Cl. B32B 3/10; B05D 5/06; B32B 15/04; B32B 3/24; B32B 3/30

(52) U.S. Cl. 428/137; 428/195.1; 428/172; 428/209; 427/270

(57) ABSTRACT

A control panel (2) for a keyboard module (1) is proposed, comprising a cost-effective genuine metal optic, said panel not having a shielding effect for antennas and capable of being manufactured and installed in a simple manner. The control panel (2) comprises a polycarbonate film (4) as a surface element, said film having a UV coating (5) on a top side and a mechanical structure (6) and having a non-conducting PVD, screen printed or NCVM coating (7) on a bottom side. Following said coating (7) is a black coating (8) with material removed at selected locations such that image structures (9) are arranged which mechanically penetrate the black coating (8) and at the same time penetrate the non-conducting PVD, screen printed or NCVM coating (7) proximate to said selected locations of the black coating (8). Following the black coating (8) is in turn a color coating (10), such that the color coating (10) covers at least the areas of the image structures (9) and in a pre-selected color, respectively.

The invention relates to a control panel for a keyboard module, a keyboard module, and a method for the manufacture of the control panel or keyboard module, respectively.

A keyboard module as an electromechanical unit comprises, generally speaking, first and second means of which, for example, the first means include those means of the keyboard module that belong to the visible and directly accessible upper part of the keyboard module and of which, for example, the second means include those means of the keyboard module that belong to the non-visible and not directly accessible lower part of the keyboard module. The first means may for example form a control panel of the keyboard module, the second means for example a switching system that is operatively connected to the control panel.

Such keyboard modules are installed in many electrical devices. An example of such devices are mobile communication terminals that must have a keyboard entry option.

Keyboard modules are known for such mobile communication terminals that use first means as referred to above comprising a thin genuine metal plate as the first visible part. Mechanical image structures that represent the keyboard symbols are etched into an associated and visible top side of the genuine metal plate. Other mechanical image structures are etched in that separate keypads and at the same time make the separated keypads functional as keys.

Therefore one use of the genuine metal plate is that of a functional element. It is also used as an optical design element, since it is high-quality, albeit expensive.

The genuine metal plate is only a component of a complete keyboard module. The genuine metal plate is completed to a keyboard module by considering and providing other, generally known means that are joined, for example, using a generally known so-called co-molding process or an also generally known gluing process.

An example of the use of a genuine metal keyboard module is the mobile communication terminal RAZR by Motorola.

As indicated above, the top side of the keyboard module is not just a functional but also a design component. In addition to using genuine metals, various coating methods can be used to influence the appearance of this part and to obtain a predetermined coating and a respective decorative surface.

Examples of such coating methods include the generally known PVD (physical vapor deposition) method, the generally known screen printing method, and the generally known NCVM (non-conductive vacuum metallization) method.

A problem of such genuine metal keyboard modules is that they are not only expensive but that they also shield antennas arranged underneath the genuine metal plate of the module from RF signals and thus at least impair their functioning.

This problem is often exacerbated, in particular in mobile communication terminals mentioned above,

in that the antennas are arranged between such a keyboard module and a battery pack on the rear side of the respective device. The batteries of the battery pack have a metal shell that also acts as an RF shield. The antenna is thus enclosed like in a cage and is hardly or not at all operational.

It is the task of this invention to improve a control panel or keyboard module of the type mentioned above in such a way that it has a cost-efficient genuine metal appearance, that it does not have a shielding effect for antennas, and that it can be manufactured and assembled easily.

It is another task of this invention to provide a method for the manufacture of a control panel or keyboard module according to the invention, respectively.

The first part of the task is solved, according to the invention, by a control panel comprising the features of claim 1 or a keyboard module comprising the features of claim 10.

The second part of the task is solved, according to the invention, by a method comprising the features of claim 11.

The control panel according to the invention comprises: a transparent polycarbonate film, said film having a scratch-resistant protective coating on its top side, said polycarbonate film with its scratch-resistant coating on its top comprising a mechanical structure, and having a non-conducting PVD, screen printed, or NCVM coating on its bottom side, and following said coating comprising a black coating with material removed at selected locations of said black coating and the

non-conducting PVD, screen printed, or NCVM coating such that image structures are arranged which mechanically penetrate the black coating and at the same time penetrate the non-conducting PVD, screen printed, or NCVM coating proximate to said selected locations of the black coating, and following said black coating comprising a color coating such that the color coating covers at least the areas of the image structures with a color.

According to an advantageous development of the invention, a protective coating is applied following the color coating and, to the extent the black coating is not covered by the color coating, following the black coating.

According to another advantageous development of the invention, the mechanical structure on the top side of the polycarbonate film comprises an at least partial key grid.

It is advantageous that at least a single location the mechanical structure on the top side of the polycarbonate film completely penetrates the polycarbonate film. In particular, insertion parts are provided at the at least one location of the mechanical structure, and said insertion parts are inserted from the bottom side of the polycarbonate film and completely pass through the polycarbonate film, on the top side of which they comprise a domed shape that projects beyond the polycarbonate film.

According to an advantageous development of the invention, the mechanical structure on the top side of the polycarbonate film comprises at least one location at which the mechanical structure extends into the surface.

According to yet another advantageous development of the invention, inlay parts are provided that are installed into the mechanical structure that extends into the surface and comprise a domed shape that projects beyond the top side of the polycarbonate film.

According to an advantageous embodiment of the invention, the non-conducting PVD, screen printed, or NCVM coating is a metal coating having so few atomic layers that it is non-conducting.

Advantageously, the mechanical structure on the top side of the polycarbonate film comprises gaps having a width of 0.1 mm and a depth of 0.15 mm, the UV coating is 10 to 15 microns in thickness, the polycarbonate film is 0.25 mm in thickness, the non-conducting PVD, screen printed, or NCVM coating is only a few atomic layers thick, the black coating is 10 microns in thickness, the color coating is 7 to 10 microns in thickness, and the protective coating is 12 microns in thickness.

The invention further relates to a keyboard module comprising a control panel as described above and a switching system that is operatively connected to it. The control panel is formed by first means and the switching system by second means, the first and second means preferably making up the electromechanical design of the keyboard module as a whole.

In the keyboard module of the invention, the first means as the top partial component comprise a transparent polycarbonate film having a UV coating and a mechanical structure that immerses deeply into the polycarbonate film on its associated top side. The polycarbonate film further comprises a non-conducting PVD, screen printed, or NCVM coating on an associated bottom side and directly adjacent to said bottom side. Following said PVD, screen printed, or NCVM coating is a black coating. Material has been removed at selected locations of the black coating such that image structures mechanically penetrate the black coating and at the same time penetrate the non-conducting PVD, screen printed, or NCVM coating adjacent to these locations of the black coating. Following the black coating, a color coating is provided such that the color coating covers at least the areas of the image structures and in a preselected color, respectively.

The coating on the bottom or inner side of the polycarbonate film is a decorative coating that can be provided in any finish using the various coating methods. The interaction of the decorative coating on the inner side of the polycarbonate film and the UV coating arranged on the top or outside of the polycarbonate film optically provides a metallic effect. This effect is obtained cost-efficiently because it does not require a genuine metal plate. The keyboard module according to the invention does not have a conducting layer covering the entire surface so that the keyboard module according to the invention does not have a shielding effect for antennas. Finally, the individual components of the keyboard module according to the invention can be manufactured and assembled easily.

An additional advantage of the keyboard module according to the invention is that it can be built in an extremely flat design.

Advantageous embodiments of the keyboard module according to the invention are the subject matter of dependent claims.

According to these, a protective coating is applied following the color coating and, where the black coating is not covered by the color coating, following the black coating onto the color coating and, where present, onto the black coating.

This protective coating prevents, for example, that the black and/or color coating is destroyed during gluing, for example when the adhesive used for gluing is destructive to the black and/or color coating.

It is preferred that the mechanical structure on the top side of the polycarbonate film comprises the structure of a key grid at least in a partial embodiment. The mechanical structure on the top side of the polycarbonate film can comprise the structure of a key grid having a highly precise and fine x/y grid structure at least in a partial embodiment. Another positive optical effect is achieved by the high precision and exactness of the grid structure. The grid forms the gaps between keys that can also frame associated key pads completely. The gap widths can have very small dimensions from 0.1 to 0.2 mm.

The mechanical structure on the top side of the polycarbonate film may comprise at least a single location where the mechanical structure extends completely through the polycarbonate film.

In particular, insertion parts are provided that are inserted from the bottom side of the polycarbonate film through the structure that completely passes through the polycarbonate film and that comprise a domed shape that projects beyond the polycarbonate film on the top side of the polycarbonate film. Insertion parts can thus be provided at these locations that are inserted from the bottom side through the polyester film and that have a domed shape projecting beyond the polycarbonate film on the top side of the polycarbonate film.

The domed shape forms a projection that can be used for tactile purposes.

The mechanical structure on the top side of the polycarbonate film may further comprise at least a single location where the mechanical structure extends into the surface of the polycarbonate film.

Inlay parts can be inserted and installed at these locations such that the insert comprises a domed shape that projects beyond the top side of the polycarbonate film. In particular, inlay parts are provided that are installed into the mechanical structure that extends into the surface and comprise a domed shape that projects beyond the top side of the polycarbonate film.

The domed shape once again forms a projection that can be used for tactile purposes.

It is preferred that the non-conducting PVD, screen printed, or NCVM coating has so few atomic layers that its non-conducting property is ensured. Non-conducting property of the PVD, screen printed, or NCVM coating is achieved at any rate if the coating comprises only a few atomic layers. In this case, especially if metal particles are used, particles are arranged at such a distance that they do not have a conducting connection and create a shielding effect when in the form of a surface.

With respect to a particular embodiment of a keyboard module according to the invention, dimensions can be produced as listed below: Gaps in the mechanical structure on the top side of the polycarbonate film can be 0.1 mm in width and 0.15 mm in depth; the UV coating can be 10 to 15 microns in thickness; the polycarbonate film can be 0.25 mm in thickness, the non-conducting PVD, screen printed, or NCVM coating can only be a few atomic layers thick, the black coating can be 10 microns in thickness, the color coating can be 7 to 10 microns in thickness, and finally the protective coating can be 12 microns in thickness.

Tolerances may have to be taken into account here.

The method according to the invention for the manufacture of a control panel, especially a control panel as mentioned above, is characterized by the following steps:

a) Cutting a blank from a colorless polycarbonate film;
b) Coating a top side of the cut-to-size polycarbonate film with a colorless protective coating that comprises a surface texture;
c) Applying a non-conducting PVD, screen printed, or NCVM coating to the bottom side of the polycarbonate film;
d) Applying a black coating to the non-conducting PVD, screen printed, or NCVM coating;
e) Carving image structures at predetermined locations of the black coating out of said black coating and at the same time out of the non-conducting PVD, screen printed, or NCVM coating;
f) Covering the image structures with a color coating;
g) Applying a protective coating to the color coating and on the portions of the black coating that are free of color coating, respectively.

In the method according to the invention, a blank is cut from a colorless polycarbonate film, and a colorless UV coating into which a surface texture may be worked is deposited on an associated top side thereof.

A non-conducting PVD, screen printed, or NCVM coating is deposited on an associated bottom side of the polycarbonate film. A black coating is then applied to this former coating. At predetermined locations of the black coating, image structures are then carved out from said black coating and at the same from the non-conducting PVD, screen printed, or NCVM coating located underneath at these locations. Then a color coating that covers at least the carved-out image structures is applied onto the black coating, wherein the respective areas of the carved-out image structures are covered with a respective preselected color. A protective coating is deposited onto the color coating or onto the black coating, respectively, where the latter is not covered by a color coating.

The protective coating has the advantage that the color coating in general and, where applicable, the black coating, will not be destroyed during later gluing of the polycarbonate film.

The final steps that follow are the ones required to finish the keyboard module as a complete electromechanical unit. This particularly includes the provision and assembly of the respective known components.

The method according to the invention is used to produce an operating panel or a keyboard module, respectively, that has the advantages described above.

An embodiment of the invention is explained in greater detail below with reference to a figure. Wherein:

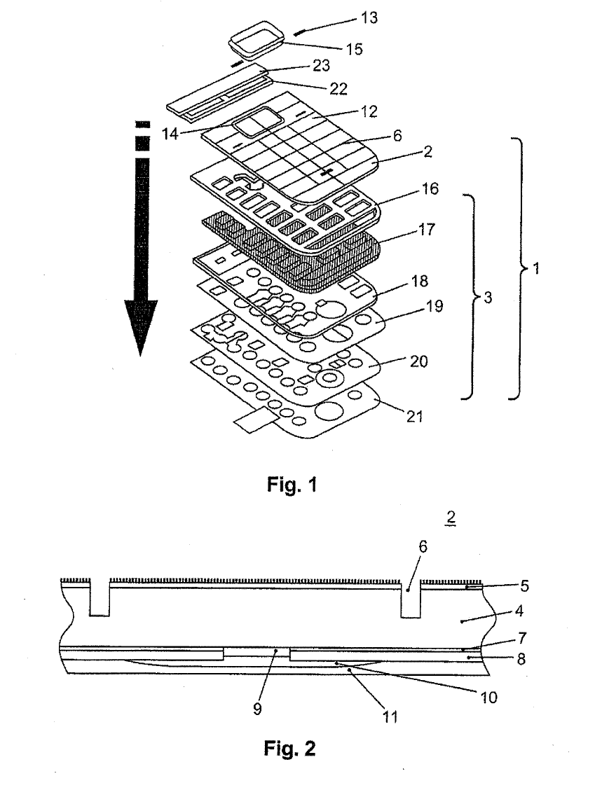

FIG. 1 shows an exploded view of a keyboard module according to the invention comprising first and second means,

FIG. 2 shows a cross sectional view of the first means of the keyboard module according to FIG. 1,

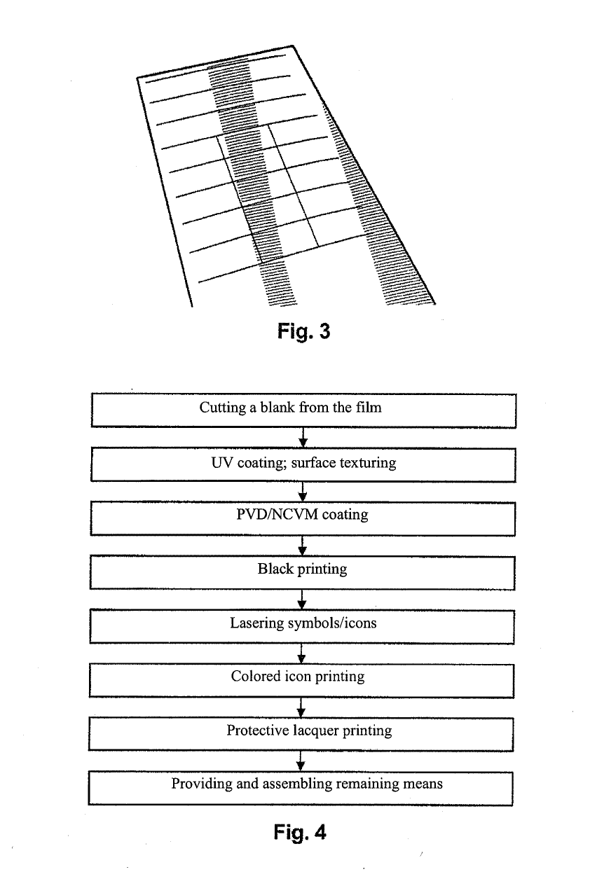

FIG. 3 shows a top view of the first means of the keyboard module according to FIG. 1,

FIG. 4 shows a flow diagram for the manufacture of a keyboard module according to FIG. 1.

The keyboard module 1 according to the invention shown in FIG. 1 as such is an electromechanical unit that can be installed into a system like other components. For example, the keyboard module 1 according to the invention shown in FIG. 1 can be installed into an associated electronic device such as a mobile communication terminal that works according to the DECT standard.

The keyboard module 1 itself comprises first and second means 2, 3, said first means 2 forming a visible and directly accessible upper part and said second means 3 forming a non-visible and not directly accessible lower part of the keyboard module 1.

The first means 2 as shown in FIG. 2 will be described in more detail below.

The first means 2 comprise, as a topmost component of the keyboard module 1 of the invention, a transparent polycarbonate film 4 comprising on a top side a UV coating 5 and a mechanical structure 6 that mechanically penetrates the UV coating and immerses into the polycarbonate film 4.

The polycarbonate film may for example be 0.25 mm in thickness.

The UV coating 5 is a special lacquer layer that is generally smooth but does have a certain surface roughness. The UV coating makes the surface scratch resistant. In addition, any desired structure can be worked into the surface. For example, it can be provided with a finish of longitudinal or circular brush strokes. This produces an improved optical design effect.

The UV coating may for example be 10 to 15 microns in thickness.

The mechanical structure 6 that penetrates the UV coating and immerses into the polycarbonate film 4 may for example reproduce the key gaps of the keyboard module 1. The mechanical structure 6 reproduces said key gaps in the form of a respective key grid. The grid can for example frame individual keypads. The key gaps may for example be 0.15 mm in depth.

A non-conducting PVD, screen printed, or NCVM coating 7 is arranged on an associated bottom side of the polycarbonate film 4.

This coating 7 is only a few atomic layers thick.

A black coating 8 follows that coating 7.

The black coating may for example be 10 microns in thickness.

Material has been removed at selected locations of the black coating 8 such that image structures 9 mechanically penetrate the black coating 8 and at the same time penetrate the non-conducting PVD, screen printed, or NCVM coating 7 adjacent to these locations of the black coating 8.

The image structures 9 specifically represent the key symbols needed in particular for keyboard modules. Through measures applied later and not of interest at this point, light radiates through the image structures 9 such that the image structures 9 are perceived as illuminated key symbols.

The black coating 8 is followed by a color coating 10 such that said color coating 10 covers at least the areas of the image structures 9. The color coating 10 can be of a preselected color for the respective areas covered. For example, a Lift Receiver icon could be green, a Put Down Receiver icon could be red while other symbols are blue.

The color coating 10 may for example be 7 to 10 microns in thickness.

According to FIG. 2, a protective coating 11 is then applied following the color coating 10 and, to the extent the black coating 8 is not covered by the color coating 10, following the black coating 8.

The protective coating 11 consists of a protective lacquer that may for example be 12 microns in thickness.

As indicated in FIG. 1 for a preferred embodiment of the invention, the mechanical structure 6 comprises

at least a single location 12 where the mechanical structure 6 extends completely through the polycarbonate film 4 on the top side of the polycarbonate film 4.

According to the present embodiment, insertion parts 13 are provided for these locations 12, said parts being inserted from the bottom side of the polycarbonate film 4 through a structure 6 which passes completely through the polycarbonate film 4 and comprising a domed shape that projects beyond the polycarbonate film 4 on the top side of the polycarbonate film 4.

As further indicated in FIG. 1, in a preferred embodiment of the invention the mechanical structure 6 comprises at least one location 14 on the top side of the polycarbonate film 4 where the mechanical structure 6 extends into the surface of the polycarbonate film 4.

Inlay parts 15 are provided for these locations 14, said parts being installed into the mechanical structure 6 that extends into the surface and comprise a domed shape that projects beyond the top side of the polycarbonate film 4.

In the embodiment shown here, only one location 14 is present so that only one insert part 15 is inserted in this embodiment.

According to FIGS. 1 and 2, the non-conducting PVD, screen printed, or NCVM coating 7 in the present embodiment is a metal coating with so few atomic layers that the non-conducting property of this coating is ensured.

A metallic effect visible in the top view of the polycarbonate film 4 (FIG. 2) is produced through the interaction of the transparent polycarbonate film 4 (FIG. 2) and the UV coating 5 (FIG. 2) applied on top of it, as it can be sketchily seen in FIG. 3.

FIG. 4 shows a flow diagram of a process for the manufacture of a keyboard module 1 having the effects mentioned above. The steps of this process do not necessarily have to be performed in exactly this order. Process steps may optionally be performed in parallel with other process steps. For example, the remaining means needed for the keyboard module 1 that according to FIG. 4 are provided in the last step of the process may also be provided at an earlier point in time so that they can be installed immediately in the last process step.

According to the steps of the method listed in FIG. 4, a blank is cut from a colorless polycarbonate film 4. Then a colorless UV coating 5 and a surface structure are applied onto the cut-to-size polycarbonate film 4.

The surface structure may for example be produced by lasers or cutters.

A non-conducting PVD, screen printed, or NCVM coating 7 is deposited onto an associated bottom side of the polycarbonate film 4. A black coating 8 is further applied to the non-conducting PVD, screen printed, or NCVM coating 7. Then image structures 9 are carved at predetermined locations of the black coating 8 out of said black coating 8 and at the same time out of the non-conducting PVD, screen printed, or NCVM coating 7, e.g. by lasering. A color coating 10 that covers at least the carved out image structures 9 is applied to the black coating 8. Preselected colors are used for the respective covering areas. Following that, a protective coating is applied onto the color coating 10 and optionally onto the black coating 8 where the latter is not covered by the color coating. Finally, the remaining means for finishing the keyboard module 1 as an electromechanical unit are provided and assembled.

According to the embodiment shown in FIG. 1, said remaining means provided and assembled include a part 16 that is known by the English term “carrier”. Said means also include a part 17 known by the English term “rubber”. Said means also include a part 18 known by the English term “adhesive”. Said means also include a part 19 known by the English term “metal dome foil”. Said means also include a part 20 known by the English term “spacer”. Finally these means include a so-called FPC film 21 with light-emitting diodes, protective resistors, and a so-called B2B connector.

The English terms for these parts are self-explanatory and their use is known to experts skilled in the art. They will not be discussed in more detail here.

The parts just mentioned comprise the second means 3. As the arrow in FIG. 1 indicates, these are stacked on one another and glued together with the first means 2. Insertion parts 13 and inlay parts are included in addition.

According to the embodiment shown in FIG. 1, additional parts 22 and 23 designated by the English terms “black foil” and “hard caps” that can be stacked onto one another over selected keypads of the polycarbonate film 4 have been included on the top side of the polycarbonate film 4. This allows the utilization of further tactile and optical effects.

To summarize once again, the keyboard module 1 according to the invention has a multi-layer design wherein the key strokes are transmitted from the decorative film to the underlying metal domes via a flexible silicone layer or a flexible plastic carrier.

Contours on the top side of the polycarbonate film 4 may for example be milled using CNC machines.

The method for manufacturing the keyboard module mentioned above is characterized in that a blank is cut out of a colorless polycarbonate film 4, that a colorless UV coating 5 is applied onto a top side of the cut-to-size polycarbonate film 4 and given a surface texturing 6, that a non-conducting PVD, screen printed, or NCVM coating 7 is applied onto a bottom side of the polycarbonate film 4, that a black coating 8 is applied onto the non-conducting PVD, screen printed, or NCVM coating 7, that image structures 9 are carved at predefined locations of the black coating 8 from the black coating 8 and at the same time from the non-conducting PVD, screen printed, or NCVM coating 7 underneath, that a color coating 10 that covers at least the carved-out image structures 9 with a preselected color is applied onto the black coating 8, that a protective coating 11 is applied onto the color coating 10 and optionally a black coating 8 not covered with a color coating 10, and that steps providing and installing remaining means 3 for competing the keyboard module 1 as an electromechanical unit are performed.

1. A control panel for a keyboard module, comprising:
a transparent polycarbonate film as the topmost component, comprising on its top side a scratch-resistant protective coating,
wherein the polycarbonate film with the scratch resistant coating on top of it is provided with a mechanical structure,
wherein the bottom side of the polycarbonate film comprises a non-conducting PVD, screen printed, or NCVM coating onto which a black coating is deposited,
wherein material has been removed from selected locations of the black coating and the nonconducting PVD, screen printed, or NCVM coating at which image structures that penetrate the black coating and at the same time the adjacent non-conducting PVD, screen printed, or NCVM coating,
wherein a color coating is applied following the black coating in such a way that said color coating covers at least areas of the image structures with a color.

2. The control panel according to claim 1, wherein a protective coating is applied following the color coating and, to the extent the black coating is not covered by the color coating, following the black coating.

3. The control panel according to claim 1, wherein the mechanical structure on the top side of the polycarbonate film comprises an at least partial key grid structure.

4. The control panel according to claim 1, wherein at least one location, the mechanical structure on the top side of the polycarbonate film extends completely through the polycarbonate film.

5. The control panel according to claim 4, wherein insertion parts are provided at the at least one location of the mechanical structure, and said insertion parts are inserted from the bottom side of the polycarbonate film and completely pass through the polycarbonate film, whereby the insertion parts comprise a domed shape on the top side of the polycarbonate film that projects beyond the polycarbonate film.

6. The control panel according to claim 1, wherein the mechanical structure on the top side of the polycarbonate film comprises at least one location at which the mechanical structure extends into the surface.

7. The control panel according to claim 1, wherein inlay parts are provided that are installed into the mechanical structure that extends into the surface and comprise a domed shape that projects beyond the top side of the polycarbonate film.

8. The control panel according to claim 1, wherein the non-conducting PVD, screen printed, or NCVM coating is a metal coating having so few atomic layers that it is non-conducting.

9. The control panel according to claim 1, wherein the mechanical structure on the top side of the polycarbonate film comprises gaps having a width of 0.1 mm and a depth of 0.15 mm, that the UV coating is 10 to 15 microns in thickness, the polycarbonate film is 0.25 mm in thickness, the nonconducting PVD, screen printed, or NCVM coating is only a few atomic layers thick, the black coating is 10 microns in thickness, the color coating is 7 to 10 microns in thickness, and the protective coating is 12 microns in thickness.

10. A keyboard module with a control panel according to claim 1 and a switching system that is operatively connected to it.

11. A method for the manufacture of a control panel, the method comprising:
Cutting a blank from a colorless polycarbonate film;
Coating a top side of the cut-to-size polycarbonate film with a colorless protective coating that comprises a surface texturing;
Applying a non-conducting PVD, screen printed, or NCVM coating to the bottom side of the polycarbonate film;
Applying a black coating to the non-conducting PVD, screen printed, or NCVM coating;
Carving image structures at predetermined locations of the black coating out of said black coating and at the same time out of the non-conducting PVD, screen printed, or NCVM coating;
Covering the image structures with a color coating; and,
Applying a protective coating to the color coating and, as required, onto the portions of the black coating that are free of color coating.
